(19) United States
(12) Patent Application Publication
(10) Pub. No.: US 2013/0159093 A1
(43) Pub. Date: Jun. 20, 2013

(54) SYSTEMS AND METHODS FOR GENERATING REVENUE BASED ON CUSTOM CLICK TO CALL ADVERTISEMENTS

(71) Applicant: Viraj Sudhir Chavan, Sunnyvale, CA (US)

(72) Inventor: Viraj Sudhir Chavan, Sunnyvale, CA (US)

(21) Appl. No.: 13/331,262

(22) Filed: Dec. 20, 2011

(51) Int. Cl. G06Q 30/02

(52) U.S. Cl. 705/14.45

(57) ABSTRACT

A system and method for generating revenue based on a custom click to advertisement over IMAP are disclosed. The system and method may receive an email from a first user and store the email from the first user on a server. In some embodiments, a custom click to call advertisement may be created for the stored email. The custom click to call advertisement may be inserted into the email. In some embodiments, the server may transmit the stored email with the inserted custom click to call advertisement to a second user. The custom click to call advertisement may be inserted as dynamic HTML tags within an email protocol. In some embodiments, a use of the custom click to call advertisement transmitted with the email to the second user may be detected.

### FIELD

The present disclosure relates to systems and methods for advertising. In some embodiments, the present disclosure relates to systems and methods for generating revenue based on custom click to call advertisements.

### BACKGROUND

The Internet is a ubiquitous medium of communication in most parts of the world. The emergence of the Internet has opened a new forum for the creation and placement of advertisements promoting products, services, and brands. Internet content providers rely on advertising revenue to drive the production of free or low cost content. Advertisers, in turn, increasingly view Internet content portals and online publications as a critically important medium for the placement of advertisements.

The interactive nature of Internet communication enables advertisers and content providers to target advertising campaigns to viewers. Advertisers may pay for the display of an advertisement to a viewer. For example, an advertiser may pay for each advertisement impression on a web page, a user clicking on an advertisement, or for a conversion of a product or service associated with the advertisement. However, such traditional advertising models are limited to web pages.

As such, it is desirable to develop systems and methods of generating revenue based on advertising beyond merely web pages. For example, custom click to call advertisements may be inserted into emails. The custom click to call advertisements may provide an additional revenue stream in addition to conventional web page advertising.

### SUMMARY

The present disclosure introduces systems and methods for generating revenue based on custom click to call advertisements.

The systems or methods may use a custom click to call advertisement. For example, the systems or methods may receive an email message and store the email message in a standardized email protocol. An advertisement may be generated at least partly based on the email message. The advertisement may comprise advertisement text and an advertisement phone number. The advertisement may be inserted into the stored email message in the standardized email protocol format to create an outbound email message with the inserted advertisement. The systems or methods may transmit the outbound email message with the inserted advertisement to a second user. Moreover, the systems and methods may detect use of the advertisement phone number of the advertisement inserted into the outbound email message by the second user.

In some embodiments, the advertisement may be inserted into the stored email message such that the outbound email message with the inserted advertisement may be received by the second user in the standardized email protocol format. As such, the custom click to call advertisement may be inserted and viewed regardless of the native client email application of the second user.

In the same or alternative embodiments, the standardized email protocol format may comprise an Internet message access protocol (IMAP) format and the advertisement may be inserted into the stored email message as dynamic HyperText Markup Language (HTML) tags.

In some embodiments, the advertisement text and the advertisement phone number may be based on the content of the text of the received email message.

In the same or alternative embodiments, the advertisement text and the advertisement phone number may be further based on a geographic location of the second user.

In some embodiments, a use of the advertisement phone number by the second user may result in the second user placing a call to an advertiser associated with the advertisement phone number.

In the same or alternative embodiments, the use of the advertisement phone number results in the second user initiating a phone call to an advertiser associated with the advertisement phone number and the advertiser associated with the advertisement phone number may be charged a fee or amount based on the second user placing the phone call to the advertisement phone number.

### BRIEF DESCRIPTION OF THE DRAWINGS

The novel features of the disclosure are set forth in the appended claims. However, for purpose of explanation, several embodiments of the disclosure are set forth in the following figures.

FIG. 1 is an example embodiment of an environment for a system and/or a method for generating revenue based on click to call advertisements in accordance with some embodiments of the disclosure.

FIG. 2 is a flow diagram of an example method for generating revenue based on click to call advertisements.

FIG. 3 depicts a diagram illustrating an email message in accordance with some embodiments of the present disclosure.

FIG. 4 depicts a diagram illustrating an email message with a custom advertisement with a click to call phone number in accordance with some embodiments.

FIG. 5 is an example flow diagram illustrating an environment for receiving an email and transmitting the email with a custom click to call advertisement in accordance with some embodiments of the present disclosure.

FIG. 6 is a flow diagram of an example method for receiving an email and detecting a use of a custom click to call advertisement.

FIG. 7 is an example embodiment of an online advertising system in accordance with some embodiments.

FIG. 8 depicts a diagram illustrating an advertisement delivery system within which some embodiments of the disclosure are implemented.

FIG. 9 depicts a diagram illustrating an advertisement delivery system within which some embodiments of the disclosure are implemented

FIG. 10 depicts a diagram illustrating an exemplary computing system for execution of the operations comprising various embodiments of the disclosure.

### DETAILED DESCRIPTION

The systems and methods disclosed herein relate to generating revenue based on click to call advertisements.

In the following detailed description, numerous specific details are set forth in order to provide a thorough understanding of the present disclosure. However, it will become obvious to those skilled in the art that the present disclosure may be practiced without these specific details. The description and representation herein are the common means used by those experienced or skilled in the art to most effectively convey the substance of their work to others skilled in the art. In other instances, well known methods, procedures, and systems have not been described in detail to avoid unnecessarily obscuring aspects of the present disclosure.

The disclosure that follows is divided into four sections. Section I contains terms used herein. Section II describes a system and method for generating revenue based on custom click to call advertisements. Section III describes an environment in which some embodiments of the present disclosure may operate.

I. Terms

Some of the terms used in the disclosure are defined below in alphabetical order. These terms are not rigidly restricted to these definitions. A term may be further defined by the term's use in other sections of the disclosure.

“Ad” (e.g., advertisement, item and/or message) may refer to a paid announcement, as of goods or services for sale. An ad may also be referred to as an ad, advertisement, an item and/or a message.

“Ad call” may refer to a message sent by a computer to an ad server for requesting an ad to be displayed (e.g., within an email). An “ad call” may be referred to as an “advertisement call.”

“Ad server” may refer to a server that is configured for serving one or more ads to user devices. An ad server may be controlled by a publisher of a website, email server, and/or an advertiser of online ads. A server is defined below.

“Advertiser” (e.g., messenger and/or messaging customer, etc.) may refer to an entity that is in the business of marketing a product and/or a service to users. An advertiser may include, without limitation, a seller and/or a third-party agent for the seller. An advertiser may also be referred to as a messenger and/or a messaging customer.

“Advertising” may refer to marketing a product and/or service to one or more potential consumers by using an advertisement. An example of advertising may comprise inserting or publishing a custom click to call advertisement into an email message.

“Application server” may refer to a server that is configured for running one or more devices loaded on the application server.

“Click” (e.g., ad click) may refer to a selection of an ad impression by using a selection device such as, for example, a computer mouse or a touch-sensitive display on a user device (e.g., a mobile device such as a smart phone).

“Client” may refer to the client part of client-server architecture. A client may comprise a user device and/or an application that runs on a user device. A client may rely on a server to perform operations. For example, an email client is an application that enables a user to send and receive email via an email server. As such, the computer running such an email client may also be referred to as a client.

“Conversion” (e.g., ad conversion) may refer to a purchase of a product and/or service that occurs as a result of a user responding to an advertisement.

“Database” (e.g., database system, etc.) may refer to a collection of data organized in such a way that a computer program may quickly select desired pieces of the data. A database may be an electronic filing system. In some instances, the term “database” may be used as shorthand for a “database management system.” A database may be implemented as any type of data storage structure capable of providing for the retrieval and storage of a variety of data types. For example, a database may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” may refer to hardware, software or a combination thereof. A device may sometimes be referred to as an apparatus. Examples of a device include, without limitation, a software application such as Microsoft Word™, an email application, or a database or hardware such as a laptop computer, a mobile device such as a smart phone, a server, a display, or a computer mouse and/or a hard disk.

“Impression” (e.g., ad impression) may refer to a delivery of an advertisement to a user device for viewing by a user.

“Item” may refer to an ad, which is defined above.

“Marketplace” may refer to a world of commercial activity where products and/or services are browsed, bought and/or sold, etc. A marketplace may be located over a network, such as the Internet. A marketplace may also be located in a physical environment, such as a shopping mall.

“Message” may refer to an ad, which is defined above.

“Messaging” may refer to advertising, which is defined above.

“Messenger” may refer to an advertiser, which is defined above.

“Network” may refer to a connection, between any two or more computers, that permits the transmission of data. A network may be any combination of networks including, without limitation, the Internet, a local area network, a wide area network, a wireless network, and/or a cellular network.

“Publisher” may refer to an entity that publishes, on a network, a web page having content and/or ads, etc.

“Server” may refer to a software application that provides services to other computer programs (and their users), on the same computer or on another computer or computers. A server may also refer to the physical computer that has been set aside to run a specific server application. For example, when the software Apache HTTP Server is used as the web server for a company's website, the computer running Apache may also be called the web server. Server applications may be divided among server computers over an extreme range, depending upon the workload.

“Software” may refer to a computer program that is written in a programming language that may be used by one of ordinary skill in the art. The programming language chosen should be compatible with the computer on which the software application is to be executed and, in particular, with the operating system of that computer. Examples of suitable programming languages include, without limitation, Object Pascal, C, C++ and/or Java. Further, the functions of some embodiments, when described as a series of steps for a method, could be implemented as a series of software instructions for being operated by a processor such that the embodiments could be implemented as software, hardware, or a combination thereof. Computer-readable media are discussed in more detail in a separate section below.

“System” may refer to a device or multiple coupled devices. A device is defined above.

“User” (e.g., consumer) may refer to an operator of a user device. A user may be a person who seeks to acquire a product and/or service. For example, a user may be a person who has composed an email or a person who has received an email with an inserted custom click to call advertisement. The term “user” may also refer to a user device, depending on the context.

“User device” (e.g., computer, mobile device, user computer, client and/or server, etc.) may refer to a single computer, mobile device, or a network of interacting computers. A user device may be a computer that a user may use to communicate with other devices over a network, such as the Internet. A user device may comprise a combination of a hardware system, a software operating system, and one or more software application programs. Examples of a user device include, without limitation, a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and/or a Sun Microsystems™ workstation having a UNIX operating system.

II. Generating Revenue Based on Custom Click to Call Advertisements

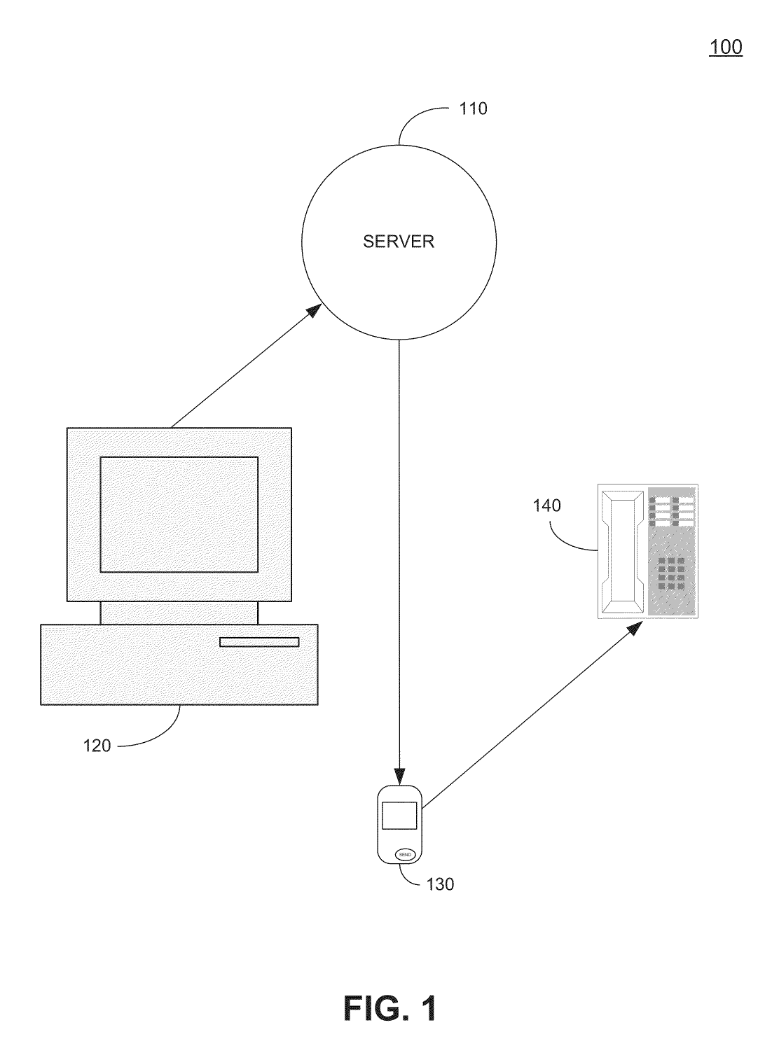

FIG. 1 is an example embodiment of an environment 100 for a system and/or a method for generating revenue based on custom click to call advertisements in accordance with some embodiments of the disclosure. In general, the environment 100 may comprise a server that receives an email from a first user, transmits the email with an inserted custom click to call advertisement to a second user, and may detect and/or track the second user interacting with or using an advertisement phone number from the inserted custom click to call advertisement.

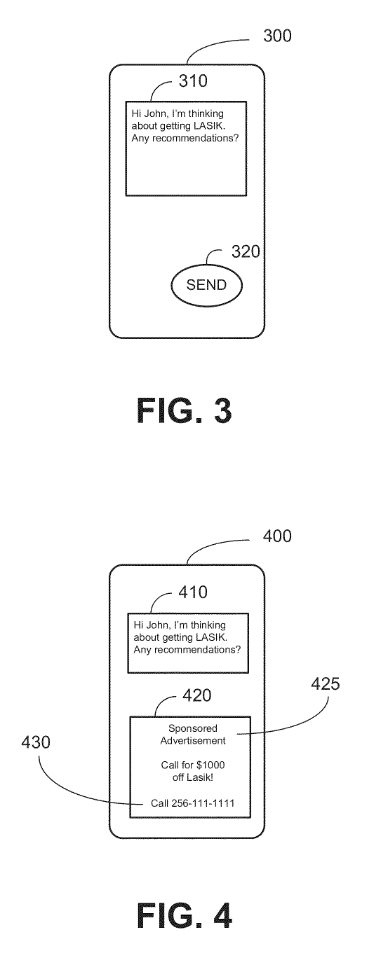

As seen in FIG. 1, the environment 100 may comprise a server 110. In some embodiments, the server 110 may comprise an email server that receives one or more emails from users and stores the emails to be viewed and/or transmitted to other users. The server 110 may receive an email from a first user 120. In some embodiments, the first user 120 may comprise a personal computer and/or a smart phone. The first user 120 may compose an email message intended to be read by a second user 130. In some embodiments, email from the first user 120 may be transmitted to the server 110 and the email may then be transmitted to the second user 130. In some embodiments, the second user 130 may comprise a smart phone with a native email client application. The server 110 may insert a custom click to call advertisement into the email message received and composed from the first user 120 and then transmit the email with a custom click to call advertisement to the second user 130. In some embodiments, the custom click to call advertisement may comprise an advertisement phone number, as will be discussed in further detail below with regard to FIGS. 3 and 4. The second user 130 may receive the email after the server 110 has inserted the custom click to call advertisement into the email message from the first user 120. In some embodiments, the second user 130 may interact with the custom click to call advertisement. For example, the second user 130 may comprise and/or use a smart phone. The second user 130 may view the email message received from the first user 120 and the inserted custom click to call advertisement and select, use, click, and/or touch the advertisement phone number associated with the custom click to call advertisement.

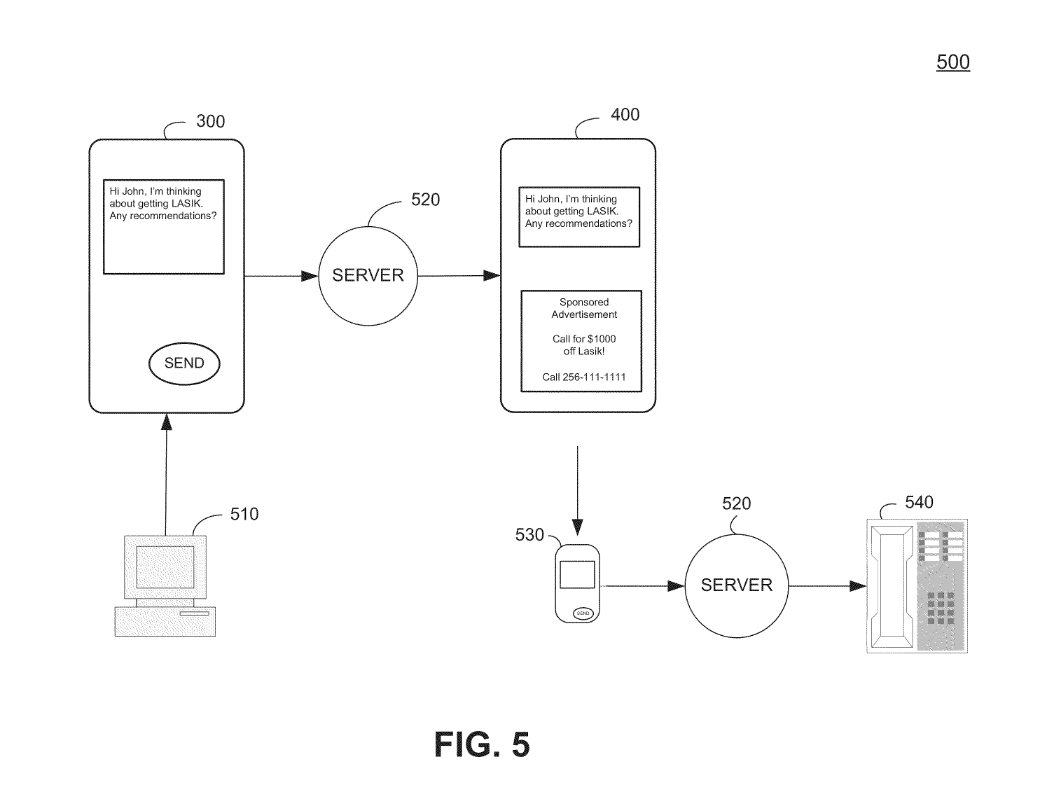

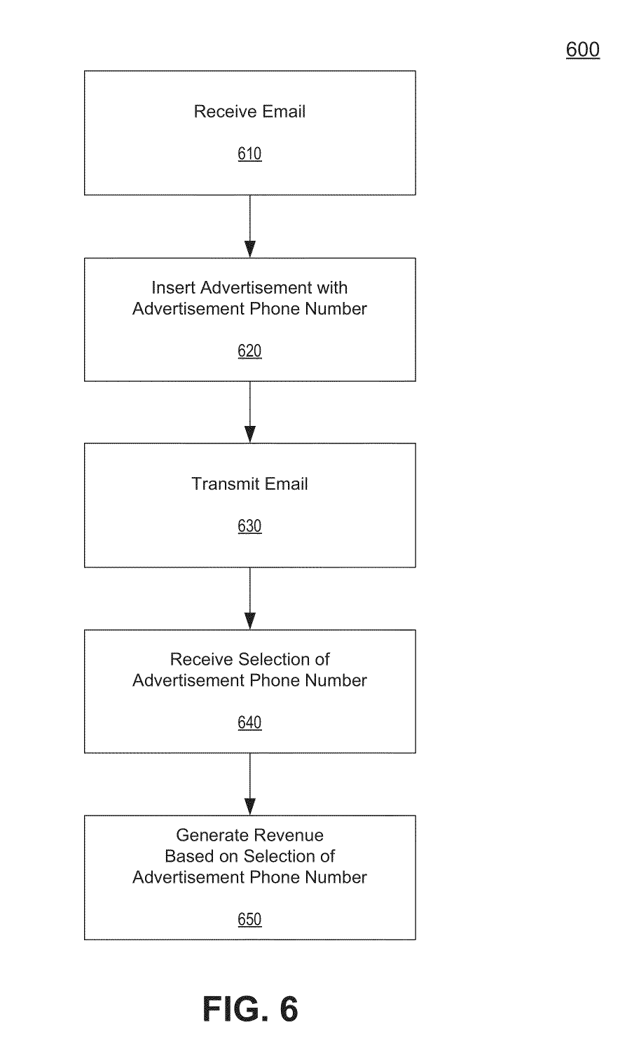

In some embodiments, after the second user 130 has selected, used, clicked, and/or touched the advertisement phone number, the second user 130 may be directed to making a phone call with the advertiser 140 associated with the custom click to call advertisement that the server 110 has inserted into the email message from the first user 120. In the same or alternative embodiments, the server 110 may detect the second user 130 viewing the custom click to call advertisement and/or selecting the advertisement phone number associated with the custom click to call advertisement to place a phone call with the advertiser 140 associated with the custom click to call advertisement. Further details with regard to detecting the second user 130 interacting with the advertisement phone number associated with the custom click to call advertisement are discussed in further detail with regard to FIGS. 5 and 6.

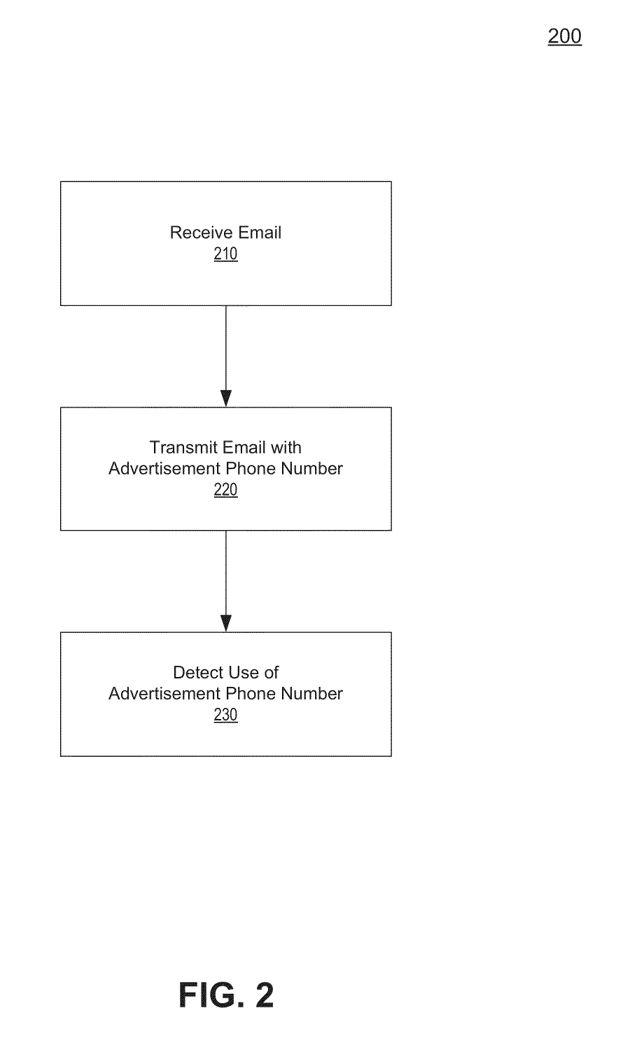

FIG. 2 is a flow diagram of an example method 200 for generating revenue based on click to call advertisements. In general, the method 200 may comprise receiving an email and detecting a use of an advertisement phone number.

As seen in FIG. 2, at block 210, an email may be received. For example, an email message may be received from a user (e.g., first user 120) who may have composed or written the email message. In some embodiments, a server (e.g., server 110) may receive the email message. The server may comprise an email exchange server. At block 220, the received email with an advertisement phone number may be transmitted to another user (e.g., second user 130). For example, a server (e.g., server 110) may transmit the email with the advertisement phone number to the other user. At block 230, a use of the advertisement phone number may be detected. In some embodiments, a server (e.g., server 110) may detect the use of the advertisement phone number.

FIG. 3 depicts a diagram illustrating an email message composition screen 300 in accordance with some embodiments of the present disclosure. In general, the email message composition screen 300 may comprise an email message written by a first user and may not display a custom click to call advertisement.

As seen in FIG. 3, the email message composition screen 300 may comprise a written email message 310. In some embodiments, the written email message may comprise identifiable subject matter (e.g., topics) that may be used to determine a custom click to call advertisement to display as discussed with regard to FIG. 4. A user (e.g., first user 120) may compose and/or write the email message 310 to be read by another user (e.g., second user 130). The email message composition screen 300 may further comprise a send or transmit button 320 such that the user may send or transmit the email message to the other user via a server (e.g., server 110). As seen in FIG. 3, the email message composition screen 300 and/or the email message 310 does not comprise a custom click to call advertisement.

FIG. 4 depicts a diagram illustrating an email message 400 with an inserted custom click to call advertisement with an advertisement phone number. In general, the email message 400 may comprise a previously transmitted email (e.g., email message 310) with a custom click to call advertisement.

As seen in FIG. 4, the email message 400 may comprise email text 410. In some embodiments, the email text 410 may be written by another user (e.g., first user 120) and transmitted to a user by a server (e.g., server 110). For example, the email text 410 may comprise an email (e.g., email message 310) that has been previously transmitted to a server. A user may receive the email message 400 after requesting the email from the server. The email message 400 may comprise the email text 410 and a custom click to call advertisement 420. In some embodiments, the custom click to call advertisement 420 may comprise advertisement text 425. In the same or alternative embodiments, the advertisement text 425 may comprise an advertisement that has been targeted to the user receiving the email message 400. The advertisement may be targeted such that the advertisement text 425 may correspond to the email text 410. For example, the custom click to call advertisement 420 may be selected to be inserted into the email message 400 based on the subject matter of the email text 410 and the subject matter of the advertisement 420. As such, the advertisement 420 may be selected to be inserted into the email message 400 based on the context of the email text 410. For example, as seen in FIG. 4, the email text 410 may comprise a message about ‘LASIK’ procedures. As such, the advertisement 420 may be selected to be inserted into the email message 400 since the advertisement 420 comprises advertisement text 425 concerning ‘LASIK’ procedures. Thus, the advertisement 420 may be selected based on keywords of the email message 400. In some embodiments, the advertisement 420 may be selected to be inserted into the email message 400 at least partly based on the geographical location of a user. If a user receiving the email message 400 is in a particular geographical area (e.g., corresponding to a first phone number area code), then the advertisement 420 may be selected based on the user's geographical area. For example, if a user is at a phone number area code of ‘256’, an advertisement 420 associated with a corresponding phone number (e.g., an advertisement phone number 430 matching the user's phone number area code of ‘256’) may be inserted into the email message 400.

As seen in FIG. 4, the advertisement 420 may comprise an advertisement phone number 430. In some embodiments, the advertisement phone number 430 may be a contact phone number for the advertiser associated with the advertisement 420. For example, the advertisement phone number 430 may comprise a phone number for a ‘LASIK’ procedure office as previously discussed with regard to the advertisement text 425. The advertisement phone number 430 may comprise custom HyperText Markup Language (HTML). For example, the advertisement phone number 430 may comprise a highlighted and/or hyperlink. In some embodiments, the user receiving the email message 400 may view the email message 400 on a native email application of a phone (e.g., a smart phone). In such a case, since the advertisement phone number 430 may comprise a custom HTML hyperlink, the advertisement phone number 430 may appear to the user of the native email application on the phone in a clickable format. Further details with regard to the advertisement phone number 430 in clickable format and detecting a click of the advertisement phone number 430 are discussed in further detail with regard to FIG. 6.

As such, the email message 400 may comprise a previously sent email from another user with an inserted custom click to call advertisement. In some embodiments, the custom click to call advertisement may be targeted (e.g., selected to be inserted into the previously sent email) based on the context of the previously sent email and/or a geographical location of the user receiving the email. The custom click to call advertisement may comprise advertisement text and/or an advertisement phone number. The user may click on the advertisement phone number to begin to make a call (e.g., with a smart phone that the user is viewing the previously sent email) with the advertiser associated with the advertisement.

FIG. 5 is an example flow diagram illustrating an environment 500 for receiving an email and transmitting the email with a custom click to call advertisement. In general, the environment 500 comprises a first user writing an email message (e.g., first user 120 writing written email message 310) to a second user receiving the email message with a custom click to call advertisement (e.g., second user 130 receiving email message 400).

As seen in FIG. 5, a first user 510 may transmit an email message 300 intended to be received by a second user 530. The email message 300 may be received by a server 520 (e.g., server 110). In some embodiments, the server 520 may insert a custom click to call advertisement into the email message 300 to create the email message with a custom click to call advertisement 400. The email message with the custom click to call advertisement 400 may be created by inserting the custom click to call advertisement 400 as dynamic HTML tags into the protocol of the email message 300. The user 530 may transmit a request to receive the email message with a custom click to call advertisement 400 from the server 520. As such, the server 520 may transmit the email message with the custom click to call advertisement 400 to the second user 530.

In some embodiments, the email message with the custom click to call advertisement 400 may be created by inserting the custom click to call advertisement into the email message 300. The server 520 may create the custom click to call advertisement in a dynamic HTML format. For example, the custom click to call advertisement may be created as dynamic HTML tags. The server 520 may insert the custom click to call advertisement dynamic HTML tags into an email protocol corresponding to the email message 300. For example, the email message 300 transmitted by the first user 510 may be stored on the server 520 and may be transmitted to the second user 530 in accordance with an email protocol. For example, when the second user 530 requests the email message 300 that is stored on the server 520, the email message with the custom click to call advertisement 400 may be transmitted based on an Internet message access protocol (IMAP) and the custom click to call advertisement dynamic HTML tags may be inserted into the IMAP protocol corresponding to the email message 300. In some embodiments, the email message with the custom click to call advertisement 400 may be transmitted based on another email protocol such as Post Office Protocol (POP). As such, the custom click to call advertisement dynamic HTML tags may also be inserted into an email message corresponding to the POP protocol.

As such, the email message stored on the server 520 may be transmitted to the second user 530 in an IMAP or POP format. The custom click to call advertisement may be inserted into the IMAP or POP protocol as dynamic HTML tags. Since the email message with the custom click to call advertisement is transmitted as an IMAP or POP based email to the second user 530, the email message with the custom click to call advertisement may be viewed by any device, platform, operating system, and email client application that may receive an IMAP and/or POP based email message. Thus, the custom click to call advertisement may be considered to be independent of the device and the native email application that a user may use on the device in order to read his or her emails.

As seen in FIG. 5, the user 530 may place a phone call to an advertiser 540. For example, the user 530 may click or tap on the custom click to call advertisement (e.g., the advertisement phone number) from the received email message with the custom click to call advertisement 400. In some embodiments, the user clicking on the custom click to call advertisement may be tracked by transmitting a communication to a server. For example, the server may be the server 520 or another independent server. When the second user 530 clicks or taps the advertisement phone number of the custom click to call advertisement, the second user 530 may be connected to a voice service (e.g., Yahoo! Voice™) that may enable the second user 530 to place a phone call to the advertiser 540. In another embodiment, when the second user 530 clicks or taps the advertisement phone number of the custom click to call advertisement, the link for the advertisement phone number may be directed to the server 520 and register with a tracking engine of the server 520 and the server 520 may transmit back a redirect link corresponding to the advertisement phone number for advertiser 540. For example, the server 520 may transmit an HTTP response 302 (e.g., an HTTP redirect) to the second user 530. In some embodiments, the redirected URL may be a “tel:” link with the advertisement phone number.

FIG. 6 is a flow diagram of a method 600 for receiving an email and detecting a use of a custom click to call advertisement. As seen in FIG. 6, at block 610, an email may be received. For example, a server may receive the email from a user at a computer or a mobile device. The received email may be stored on the server. At block 620, an advertisement may be inserted into the email stored on the server. For example, an advertisement with an advertisement phone number may be inserted into the email in an IMAP format. The advertisement with the advertisement phone number may be inserted into the email in IMAP format as dynamic HTML tags. At block 630, the email with the inserted advertisement may be transmitted in the IMAP format to a user. In some embodiments, since the email with the inserted advertisement is transmitted in the IMAP format, the email with the inserted advertisement may be read and/or interacted with by the user as long as the user's native email application client (e.g., an email application running on the user's mobile device) is enabled to receive IMAP based emails. At block 640, a selection of the advertisement phone number may be received. For example, a server may receive a notification or transmission that the user of a mobile device that has received the email has clicked on or tapped on an advertisement phone number. At block 650, revenue may be generated based on the selection of the advertisement phone number. For example, revenue may be generated (e.g., an advertiser paying a fee) based on each time a user has clicked on the advertisement phone number. In some embodiments, revenue may be generated each time the advertisement phone number is displayed on a mobile device from an email that has the advertisement phone number inserted into it.

III. Custom Click to Call Advertisement Delivery System Environment

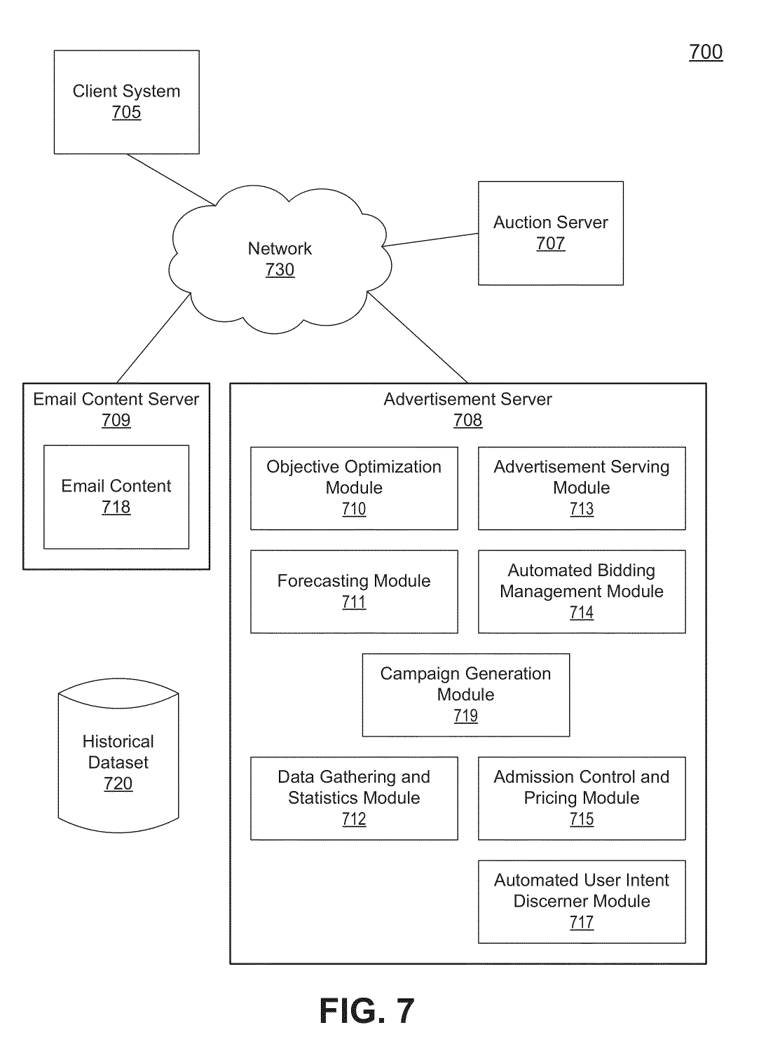

FIG. 7 is an example of an online advertising system environment 700. For example, the online advertising system environment 700 may insert a custom click to call advertisement into an email as discussed above. As such, in some embodiments, the methods 100 and 600 as described with regard to FIG. 2 and FIG. 6 may be used in conjunction with the online advertising system environment 700. In the context of online (e.g., email) advertising, placement or insertion of custom click to call advertisements within an email may use the online advertising system environment 700. An internet advertiser or agent may select a particular online property (e.g., an email service), and may create an advertisement such that whenever any online user, via a client system 705 (e.g., a mobile device such as a smart phone), requests an email from the email service, the advertisement (e.g., a creative) is composited or inserted into the email message by one or more servers (e.g., a base content server 709 and/or an advertisement server 708) for delivery to a client system 705 over a network 730. Using such a delivery model and the systems and methods disclosed herein, sophisticated advertising techniques may be practiced.

As seen in FIG. 7, an online property (e.g., an email server hosting email content 718 on an email server 709) may measure the characteristics of users (e.g., where recipients of the stored emails on the email server 709 may have any arbitrary interest, demographic, target predicates, or other attributes) using an advertisement server 708 in conjunction with a data gathering and statistics module 712, and using a historical dataset 720 as pertains to user behavior that has been observed. Thus, an online user's demographics and interest might be ‘known’ in quite some detail as it pertains to a wide range of user queries, interest categories, or other demographics or attributes. Also, behaviors (e.g., the likelihood of a click or other measurable event) might be known in quite some detail, not only for a particular user, but also for a group of users corresponding to a particular subset of the available data. Such characteristics (i.e., one or more characteristics) and/or features (i.e., one or more features) can be used in statistical modeling of users. That is, a given model can predict the likelihood p of a click c based on a feature set, and thus, a given model can be used to calculate probability p(c|x), that quantity being the probability of a user click response based on the constituents of x. Similarly, a likelihood of a user placing a phone call by using a custom click to call advertisement may also be predicted.

Such characteristics (i.e., one or more characteristics) and/or features can be used in the statistical modeling of users, even to the extent that a forecasting module 711, possibly in conjunction with a data gathering and statistics module 712, may forecast future supply accurately of opportunities to insert custom click to call advertisements into emails.

In some embodiments, the online advertising system 700 may host a variety of modules to serve management and control operations (e.g., an objective optimization module 710, a forecasting module 711, a data gathering and statistics module 712, an advertisement serving module 713, an automated bidding management module 714, an admission control and pricing module 715, etc.) pertinent to aiding advertisers in defining effective custom click to call advertisement campaigns and to service custom click to call advertisements to users. In particular, the modules, network links, algorithms, forecasting techniques, serving policies, and data structures embodied within the online advertising system 700 may be specialized so as to perform a particular function or group of functions reliably while observing capacity and performance requirements. For example, a campaign generation module 719 and/or an automated user intent discerner module 717 can operate partly in an offline (or batch) mode and partly in an online (or interactive) mode. Further, a database for storing the historical dataset 720 (which can also store historical click data such as use of a custom click to call advertisement and/or forecasted data) can operate in an online mode and/or in an offline mode. As shown, and without regard to allocation of any particular operation to any particular mode, an auction server 707 and an automated user intent discerner module 717 may be used to insert a custom click to call advertisement into an email.

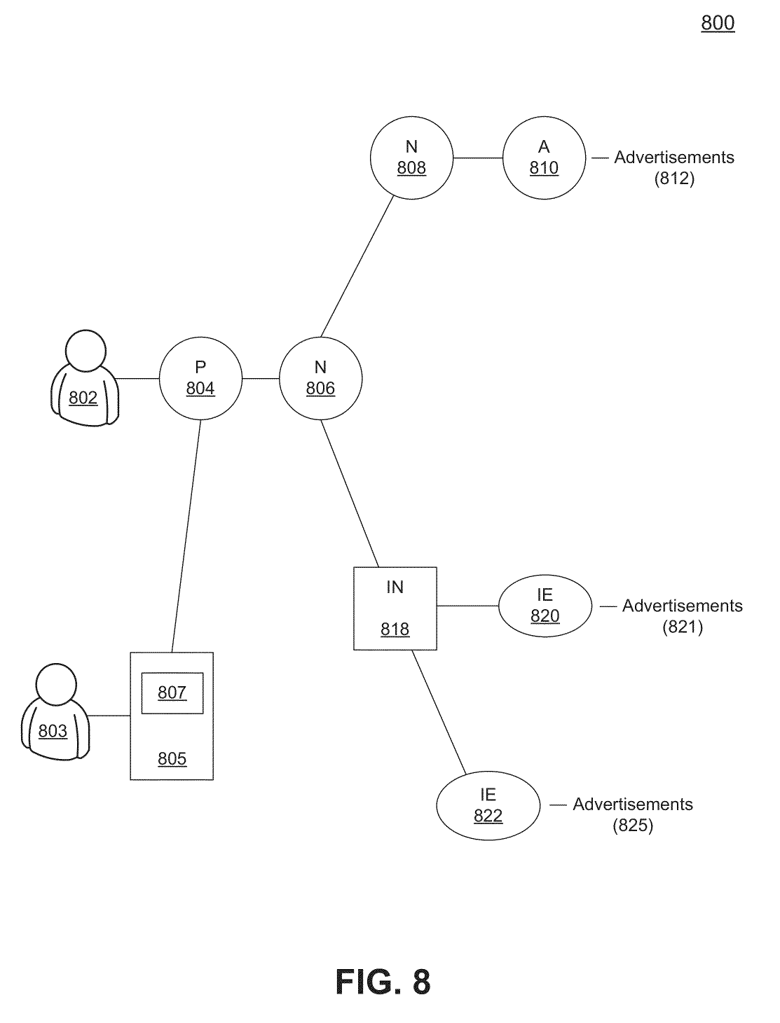

FIG. 8 illustrates an advertisement delivery system environment 800 within which some embodiments of the disclosure are implemented. In general, the embodiments described herein may be implemented as part of an advertising exchange service. An advertising exchange service may integrate entities such as advertisers and publishers (e.g., an email service). An advertising exchange service may operate in conjunction with advertisers and email service in order to deliver or insert custom click to call advertisements, from one or more advertisers, to emails received by one or more users.

An integrator network entity may define a participant of the advertising exchange system that represents or integrates one or more entities on the advertising exchange system (e.g., advertisers, email service host, advertising networks, etc.). For example, an integrator network may represent advertisers on the advertising exchange system in order to deliver advertisements to email service hosts, advertising networks and other integrator networks. In some embodiments, the integrator networks are referred to as the “users” of the advertising exchange system. The integrated networks may comprise third party agents that operate on behalf of or are part of the integrator network. The term “third party agent” may be used to generally describe an agent or customer that participates in transactions on the advertising exchange system. Similarly, the term “third party recipient” may be used to describe a user or participant of the advertising exchange system that receives information from the system, such as bid requests. However, the terms integrator networks, third party agents and third party recipients may be intended to represent a broad class of entities, including email service hosts, advertisers and networks, as well as the agents that represent them, that operate on the advertising exchange system.

As shown in FIG. 8, the system 800 includes a plurality of entities end users 802 and 803, one or more email service hosts 804, networks 806 and 808, and/or advertisers 810. The advertisement delivery system 800 further includes one or more integrator networks (IN) 818 that have one or more integrated entities (IE) 820 and 822. The various entities, including users, email service hosts, networks, advertisers, integrator networks and integrated entities, illustrated in FIG. 8 are merely exemplary, and one of ordinary skill recognizes that the system 800 may include any number of entities. Moreover, the various entities are coupled together in different advantageous configurations such as, for example, the exemplary configuration as seen in FIG. 8.

The user 803 may access information and/or content provided by the email service host 804. For example, a user accessing information and/or content may comprise an email client 805 displaying an email comprising inventory location(s) 807 for the presentation of advertisement(s). In some embodiments, an advertisement call is generated that requests an advertisement, from advertisements or advertisers 812, 820 and 821, for placement with the inventory location 807. The corresponding advertisement may be delivered to email service host 804 by one or more networks. In some embodiments, the network 806 may be coupled to the email service host 804 and the network 808 may be coupled to the advertiser 810. As such, the networks 806 and 808 are coupled to each other. The advertiser 810 may have one or more advertisement campaigns such that each advertisement campaign comprises one or more advertisements 812 that the advertiser 810 wishes to place with the inventory of email service hosts such as, for example, the inventory location 807 of the email service host 804 that may be presented to the user 803 via the email client application 805.

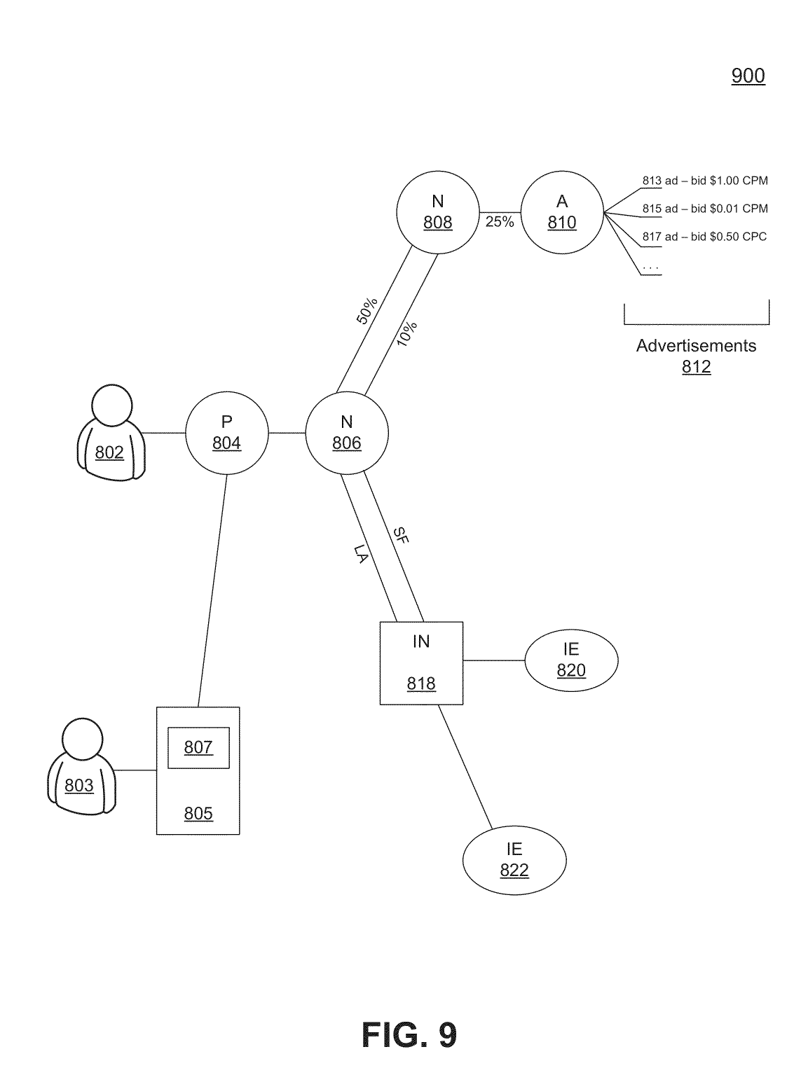

FIG. 9 is another example of an advertisement delivery system 900. In this example, the advertisements 813, 815, and 817 each may have an associated bid that the advertiser 810 will pay for the placement or insertion of the advertisement with the inventory and for presentation to the user(s). The advertisement 813 may have a bid of $1.00 cost per thousand email impressions (“CPM”), the advertisement 815 may have a bid of $0.01 CPM, and the advertisement 816 may have a bid of $0.50 cost per click (“CPC”) and placing a phone call by using the advertisement phone number of the custom click to call advertisement. One of ordinary skill in the art would recognize that any different type of advertisement bid may be used in the advertisement delivery system 900. Examples of bids include, but are not limited to, CPM, CPC, and cost per action (“CPA”).

As seen in FIG. 9, the entities along the chain of distribution for the advertisements have various revenue sharing agreements. For example, the network 808 may have a 25% revenue sharing agreement with the network 806 for fees paid by the advertiser 810. Similarly, the network 806 may have 50% and 10% revenue sharing agreements with the publisher 804 for fees paid to the network 806 by way of the network 808. The multiple revenue sharing agreements between entities may be for different advertisement campaigns and/or for targeting advertisements to different segments of users (e.g., groups of users). For example, the 50% revenue sharing agreement between networks 808 and 806 may be used to target a user segment that comprises males under 40 years old who have an interest in sports. In some embodiments, the 10% revenue sharing agreement may be used to target females over 30 years old who have an interest in gardening. As such, network 808 may deliver users of the target user segment to network 806, and network 806 is the exclusive representative of the email service host 804. One of ordinary skill in the art recognizes many different payment and/or targeting schemes.

In the same or alternative embodiments, an advertisement call for the inventory 807 may be directed to an integrator network 818. For example, the advertisement call may passed from the network 806 to the integrator network 818 with additional information. In some embodiments, the additional information may comprise a geographic location for the destination of the advertisement. For example, an advertisement call may have a destination of San Francisco (SF), while a second advertisement call may have a destination of Los Angeles (LA). Based on the advertisement call and/or information, the integrator network 818 may selectively respond to advertisement calls for, or on behalf of, one or more of its integrated entities 820 and/or 822. The integrated entities 820 and 822 may include third party entities, such as advertisers, that transact on the exchange by using an intermediary, such as the integrator network 818.

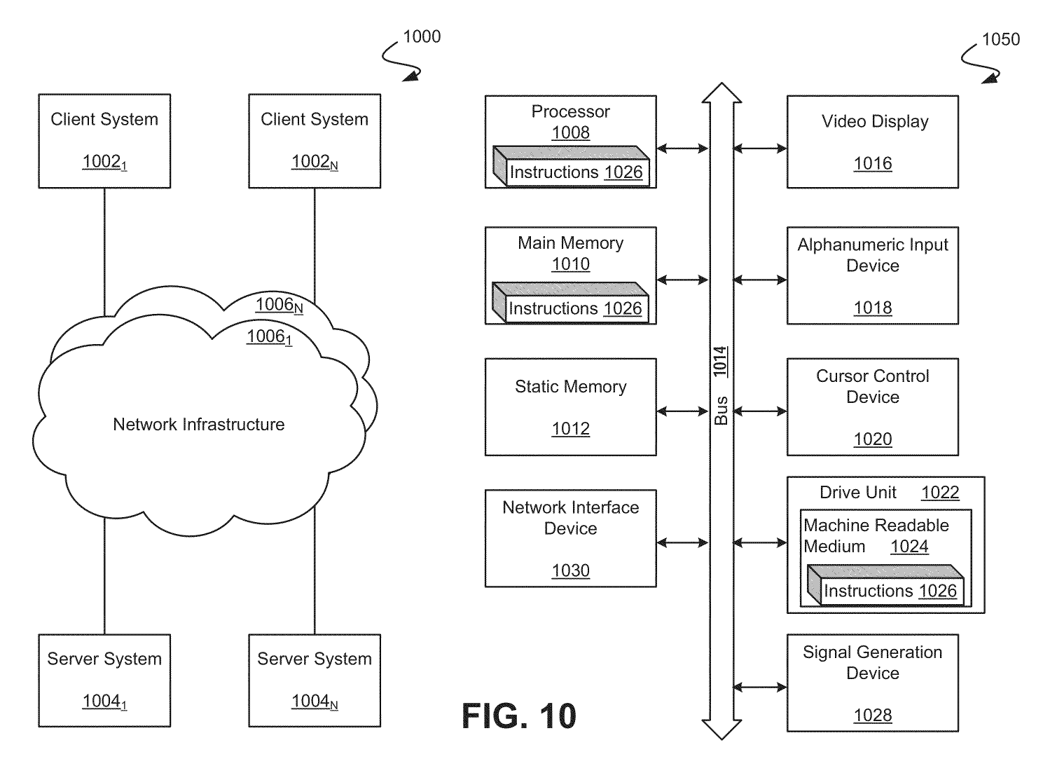

FIG. 10 is a diagrammatic representation of a network 1000, including nodes for client computer systems 1002₁ through 1002_{N}, nodes for server computer systems 1004₁ through 1004_{N}, nodes for network infrastructure 1006₁ through 1006_{N}, any of which nodes may comprise a machine 1050 within which a set of instructions for causing the machine to perform any one of the techniques discussed above may be executed. The embodiment shown is purely exemplary, and might be implemented in the context of one or more of the figures herein.

Any node of the network 1000 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1050 includes a processor 1008 (e.g. a processor core, a microprocessor, a computing device, etc.), a main memory 1010 and a static memory 1012, which communicate with each other via a bus 1014. The machine 1050 may further include a display unit 1016 that may comprise a touch-screen, or a liquid crystal display (LCD), or a light emitting diode (LED) display, or a cathode ray tube (CRT). As shown, the computer system 1050 also includes a human input/output (I/O) device 1018 (e.g., a keyboard, an alphanumeric keypad, etc.), a pointing device 1020 (e.g., a mouse, a touch screen, etc.), a drive unit 1022 (e.g. a disk drive unit, a CD/DVD drive, a tangible computer readable removable media drive, an SSD storage device, etc.), a signal generation device 1028 (e.g. a speaker, an audio output, etc.), and a network interface device 1030 (e.g. an Ethernet interface, a wired network interface, a wireless network interface, a propagated signal interface, etc.).

The drive unit 1022 includes a machine-readable medium 1024 on which is stored a set of instructions (i.e. software, firmware, middleware, etc.) 1026 embodying any one, or all, of the methodologies described above. The set of instructions 1026 is also shown to reside, completely or at least partially, within the main memory 1010 and/or within the processor 1008. The set of instructions 1026 may further be transmitted or received via the network interface device 1030 over the network bus 1014.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

1. A method for using a custom click to call advertisement, the method comprising:
receiving an email message;
storing, by a computer, the email message in a standardized email protocol format;
generating an advertisement at least partly based on the email message, the advertisement comprising advertisement text and an advertisement phone number;
inserting the advertisement into the stored email message in the standardized email protocol format to create an outbound email message with the inserted advertisement;
transmitting the outbound email message with the inserted advertisement to a second user; and
detecting a use of the advertisement phone number of the advertisement inserted into the outbound email message by the second user.

2. The method of claim 1, wherein the advertisement is inserted into the stored email message such that the outbound email message with the inserted advertisement is received by the second user in the standardized email protocol format.

3. The method of claim 1, wherein the standardized email protocol format comprises an Internet message access protocol (IMAP) format and the advertisement is inserted into the stored email message as dynamic HyperText Markup Language (HTML) tags.

4. The method of claim 1, wherein the advertisement text and the advertisement phone number are based on the content of the text of the received email message.

5. The method of claim 4, wherein the advertisement text and the advertisement phone number are further based on a geographic location of the second user.

6. The method of claim 1, wherein the use of the advertisement phone number by the second user results in the second user placing a call to an advertiser associated with the advertisement phone number.

7. The method of claim 6, the method further comprising:
charging the advertiser associated with the advertisement phone number based on the second user using the advertisement phone number and placing the phone call to the advertiser.

8. A non-transitory computer readable medium carrying one or more instructions for using a custom click to call advertisement, wherein the one or more instructions, when executed by one or more processors, causes the one or more processors to perform the steps of:
receiving an email message;
storing the email message in a standardized email protocol format;
generating an advertisement at least partly based on the email message, the advertisement comprising advertisement text and an advertisement phone number;
inserting the advertisement into the stored email message in the standardized email protocol format to create an outbound email message with the inserted advertisement;
transmitting the outbound email message with the inserted advertisement to a second user; and
detecting a use of the advertisement phone number of the advertisement inserted into the outbound email message by the second user.

9. The non-transitory computer readable medium of claim 8, wherein the advertisement is inserted into the stored email message such that the outbound email message with the inserted advertisement is received by the second user in the standardized email protocol format.

10. The non-transitory computer readable medium of claim 8, wherein the standardized email protocol format comprises an Internet message access protocol (IMAP) format and the advertisement is inserted into the stored email message as dynamic HyperText Markup Language (HTML) tags.

11. The non-transitory computer readable medium of claim 8, wherein the advertisement text and the advertisement phone number are based on the content of the text of the received email message.

12. The non-transitory computer readable medium of claim 11, wherein the advertisement text and the advertisement phone number are further based on a geographic location of the second user.

13. The non-transitory computer readable medium of claim 8, wherein the use of the advertisement phone number by the second user results in the second user placing a call to an advertiser associated with the advertisement phone number.

14. The non-transitory computer readable medium of claim 13, the steps further comprising:
charging the advertiser associated with the advertisement phone number based on the second user using the advertisement phone number and placing the phone call to the advertiser.

15. A system, comprising at least one processor and memory, for using a custom click to call advertisement, the system comprising:
a module to receive an email message;
a module to store the email message in a standardized email protocol format;
a module to generate an advertisement at least partly based on the email message, the advertisement comprising advertisement text and an advertisement phone number;
a module to insert the advertisement into the stored email message in the standardized email protocol format to create an outbound email message with the inserted advertisement;
a module to transmit the outbound email message with the inserted advertisement to a second user; and
a module to detect a use of the advertisement phone number of the advertisement inserted into the outbound email message by the second user.

16. The system of claim 15, wherein the advertisement is inserted into the stored email message such that the outbound email message with the inserted advertisement is received by the second user in the standardized email protocol format.

17. The system of claim 15, wherein the standardized email protocol format comprises an Internet message access protocol (IMAP) format and the advertisement is inserted into the stored email message as dynamic HyperText Markup Language (HTML) tags.

18. The system of claim 15, wherein the advertisement text and the advertisement phone number are based on the content of the text of the received email message.

19. The system of claim 18, wherein the advertisement text and the advertisement phone number are further based on a geographic location of the second user.

20. The system of claim 15, wherein the use of the advertisement phone number results in the second user initiating a phone call to an advertiser associated with the advertisement phone number, the system further comprising:
a module to charge the advertiser associated with the advertisement phone number based on the second user using the advertisement phone number and placing the phone call to the advertiser.
